(19) United States
(12) Patent Application Publication
(10) Pub. No.: US 2015/0261740 A1
(43) Pub. Date: Sep. 17, 2015

(54) TEXT READING AID

(71) Applicant: HEINZ GRETHER PC, Austin, TX (US)

(72) Inventors: Nick Archdale, London (GB); Arthur Ewen, London (GB)

(21) Appl. No.: 14/436,428

(22) PCT Filed: Oct. 16, 2013
(86) PCT No.: PCT/US13/65299

§ 371 Date: Apr. 16, 2015

Related U.S. Application Data
(60) Provisional application No. 61/714,335, filed on Oct. 16, 2012.

(51) Int. Cl. G06F 17/27; G06F 17/21

(52) U.S. Cl. CPC G06F 17/2705; G06F 17/21

(57) ABSTRACT

Described is reading aid for magnifying and re-laying out text in reading order without the need for optical character recognition.

### RELATED APPLICATION

The present application claim priority of provisional patent application 61/714,335 filed on 16 Oct. 2012.

### TECHNICAL FIELD OF THE INVENTION

The present invention generally relates to means for magnifying text on a printed or otherwise published document or object, specifically to a system which re-lays out text to facilitate reading without the need for character recognition—optically or otherwise.

### BACKGROUND OF THE INVENTION

It is well known to use magnifiers and lenses to enlarge text to facilitate reading. This can be helpful for those with less than perfect eyesight, or to aid reading very small print in poor lighting conditions. In particular someone with poor eyesight may use a simple lens to help them in reading books, newspapers, magazine and the labels on objects or packages. In more recent times more sophisticated versions of these devices have become available where a digital camera scans or photographs the text area and then enlarges it on a display screen. The user can choose how much magnification they need and can enjoy a larger version with enhanced contrast. Such systems may use a small camera, such as a webcam, connected to a computer running custom software, or the entire functionality may be built into a Smartphone or tablet computer with an integrated camera and a suitable application. However, a drawback of such systems is that it is incumbent on the user to move the camera along and across the text to read across and down a page, the user also has to recognize columns in the text and alter their scanning pattern accordingly. It can be very difficult to hold the camera steady while performing such scanning and the end result is suboptimal. An alternative, more sophisticated, technique in the prior art is to photograph or scan the entire page of text in one image and then turn that image, using optical character recognition (OCR) techniques into a digital character by character representation of the text. That digital copy of the text is then treated like any textual character file and can be formatted and displayed to suit a magnified screen layout. Disadvantages of such a technique are that OCR processing is costly in both processing time and complexity, and that there are significant limitations and restrictions on the font styles that OCR techniques can reliably recognize. Script fonts and handwriting are particularly prone to errors. Additionally, OCR is typically restricted to a specific character set or language, and has problems with specialized or specialist symbols and/or glyphs.

FIGS. 1, 2 and 3 show an example of a typical prior art text magnifying system. FIG. 1 illustrates a page 10 with text 12. FIG. 2 illustrates the page 10 from FIG. 1 with the view area 14 of the camera or scanner illustrated by an overlaid broken-line rectangle.

FIG. 3 shows the end result where display device 16 shows magnified content 18 which represents the scanned area 14 in FIG. 2. Note that although the magnified text 18 is easier to read, words and lines 17 are cut off so the document cannot be read fully from the static image—the lines and do not flow from one line to the next. Instead, in FIG. 2, the user must move viewed area 14 from left to right and down in a scanning pattern as they read to cover the entire page 10. The only clue to location is the textual content and where the text is cut off. This is difficult to do smoothly and accurately and leads to a disappointing, tedious and frustrating experience for the user.

It would be advantageous to have a text magnifying system which was capable of formatting a page of text for magnified reading without having to the ability to recognize the text and not be restricted by the font, style and layout of the text.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a page of text;

FIG. 2 illustrates a prior art text magnification system;

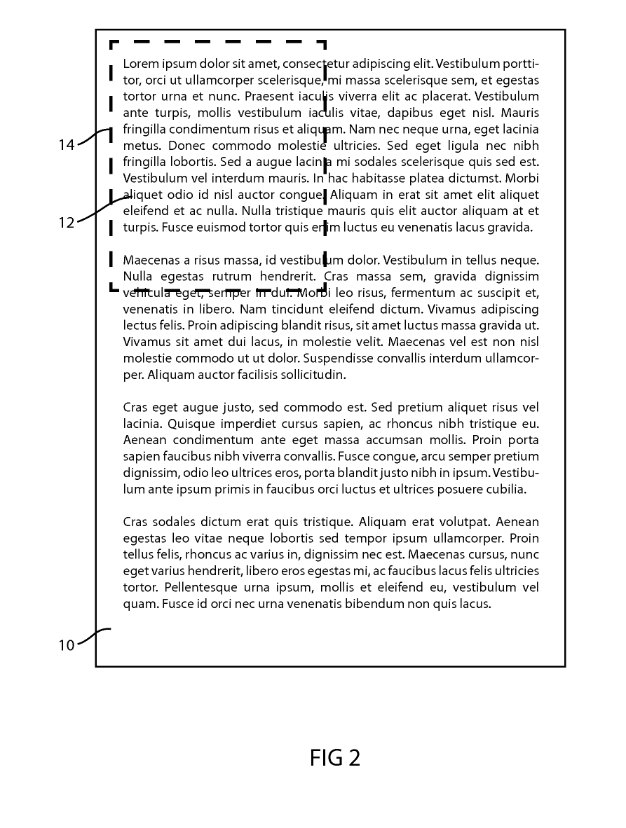

FIG. 3 illustrates the output of a prior art text magnification system;

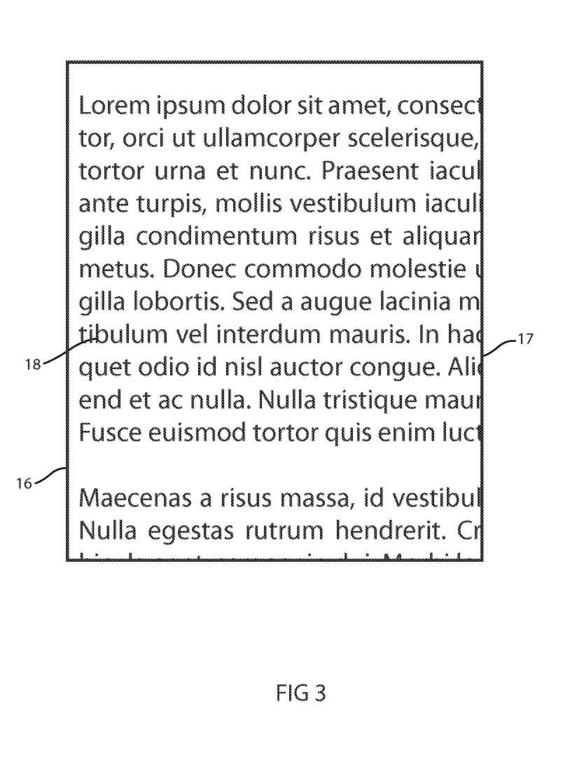

FIG. 4 illustrates an embodiment of an improved text magnification system;

FIG. 5 illustrates the text which the system in FIG. 4 selects for magnification;

FIG. 6 illustrates the output of the embodiment of the text magnification system of FIGS. 4 and 5;

FIG. 7 illustrates the embodiment of text magnification system operating on a two column text document;

FIG. 8 illustrates the text which the system in FIG. 7 selects for magnification;

FIG. 9 illustrates the output of the embodiment of the text magnification system of FIGS. 7 and 8;

FIG. 10 illustrates the flow chart of a prior art text magnification system, and;

FIG. 11 illustrates the flow chart of an embodiment of the improved text magnification system.

### DETAILED DESCRIPTION OF THE INVENTION

Preferred embodiments of the present invention are illustrated in the FIGUREs, like numerals being used to refer to like and corresponding parts of the various drawings.

The present invention generally relates to means for magnifying text on a printed or otherwise published document or object, specifically to a system which re-lays out text to facilitate reading without the need for optical character recognition.

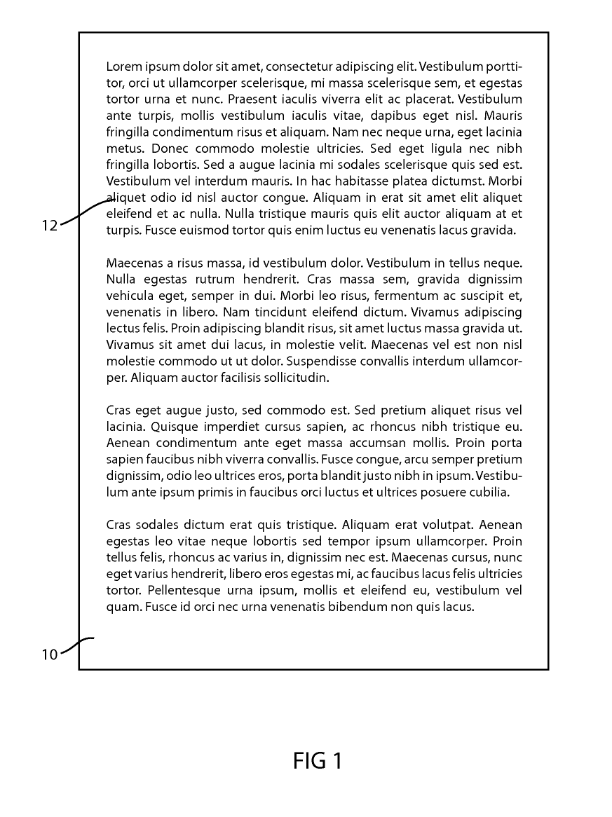

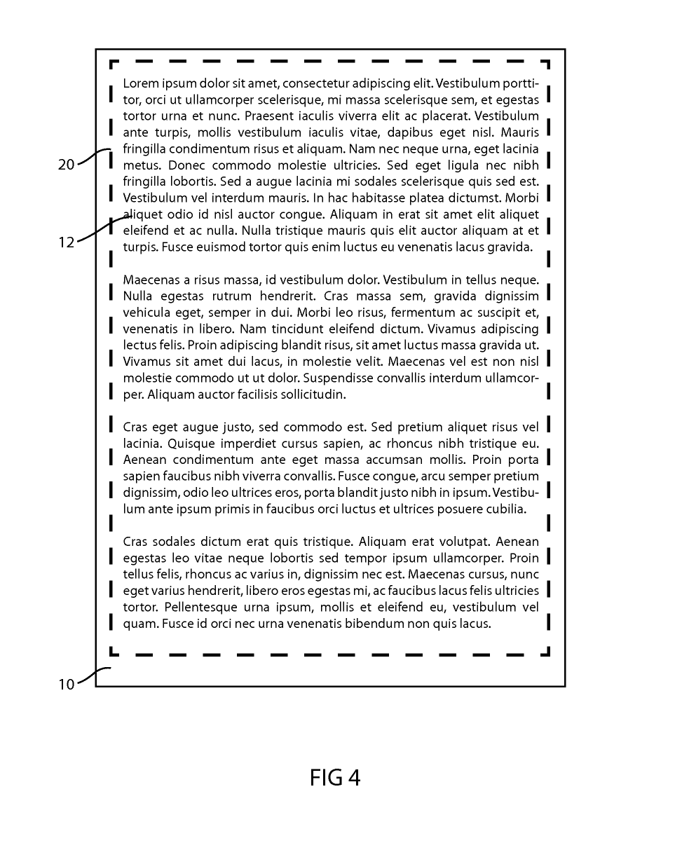

FIG. 1 illustrates a page of text 10 with text 12. FIG. 4 illustrates that same page 10 with the view area 20 of the camera or scanner of the invention overlaid illustrated via a broken lined rectangle. Note that the view area may include the entire page of text or just a portion of the document depending on the users interest.

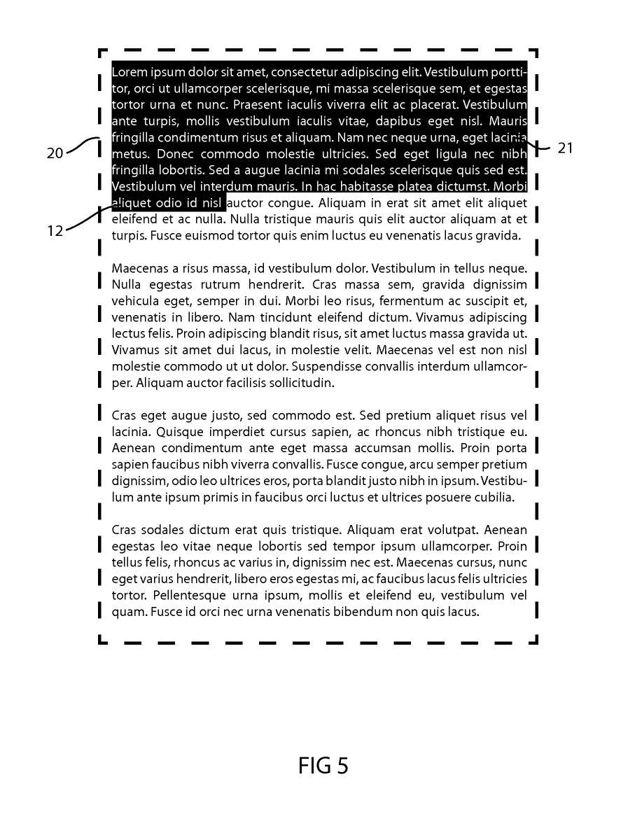

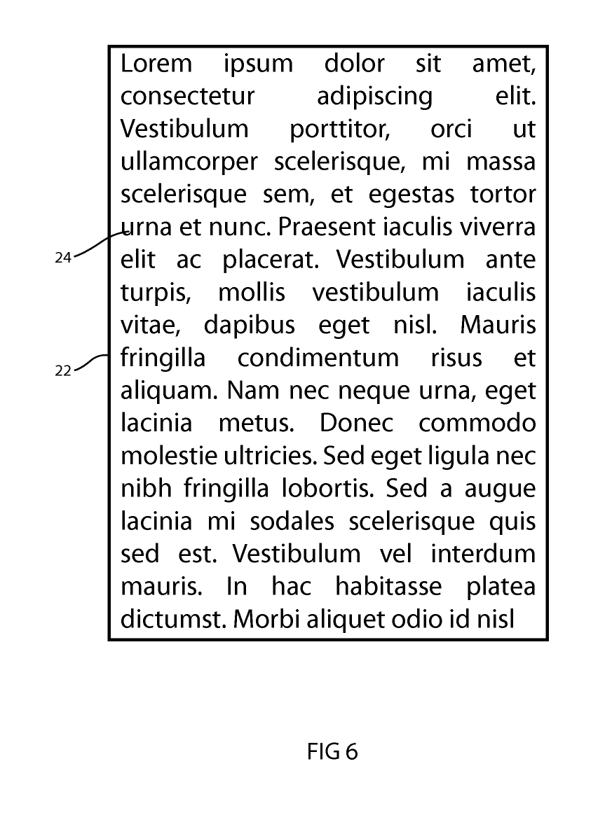

FIG. 5 illustrates the recognition phase of the invention process. The invention examines the scan or image of the text page 20 containing text 12. The invention does not attempt to recognize individual characters or perform any type of optical character recognition (OCR). Instead the invention system examines the scanned area as a bitmap image and searches for the spaces between words and the spaces between lines and formatting breaks. These will show up as contiguous areas of the background color and can be readily identified from the contrasting blocks containing text. It is a key point of the invention that, at no time, is there any attempt to interpret the blocks of text, only look for the gaps or breaks between them. Thus the text can be in any language, any font, any script, and written in any direction. Left to right, right to left, top to bottom, bottom to top. The system will work with handwritten text and any kind of symbols or glyphs. The only requirement being that there are gaps between words or glyphs. FIG. 5 shows that the system has identified area 21 (shown inverted for clarity) containing text blocks separated by gaps. The system may then magnify, re-layout and move the identified blocks around so as to format them 24 to fit the output display 22 as shown in FIG. 6.

Note that, unlike a prior art OCR system, the text is not regenerated, instead the blocks containing text are simply magnified in a bitmapped manner. The system neither possesses nor needs to know the actual content of each textual block as they are treated as images. A further advantage of the system is that it may be insensitive to angle or skew of the image. There is no need for the camera/scanner to be lined up precisely with the text page, the text can be slanted and the system is not affected. After the user has read the content 24 on display 22, they will indicate to the system to move to the next ‘page’ through a user control and the system will format the next image blocks of text in the same manner and display them on screen 22. This process can continue until the entire page of text has been displayed in its magnified reformatted state.

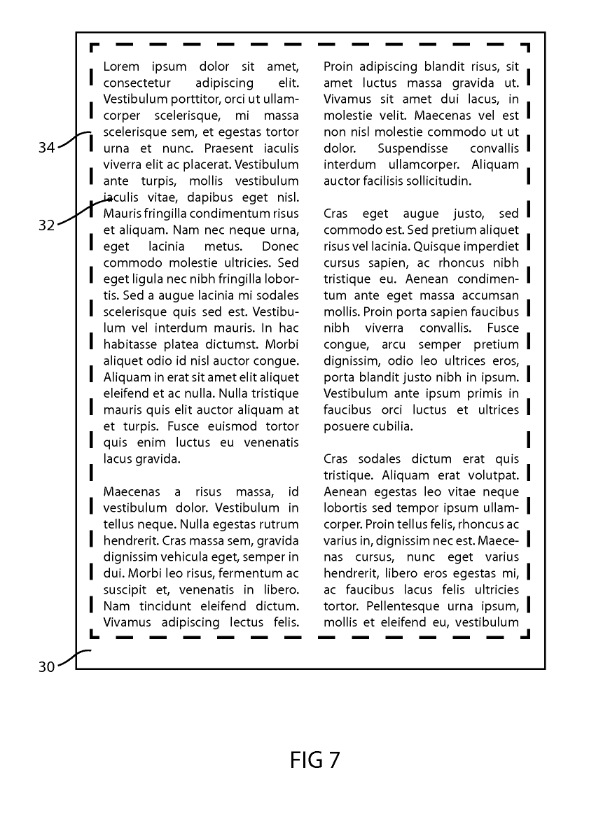

In a further embodiment of the invention multi-column text may also be correctly magnified and laid out for the user. FIG. 7 illustrates a page 30 of text 32 with the view area 34 of the camera or scanner of the invention illustrated by overlaid broken-line rectangle.

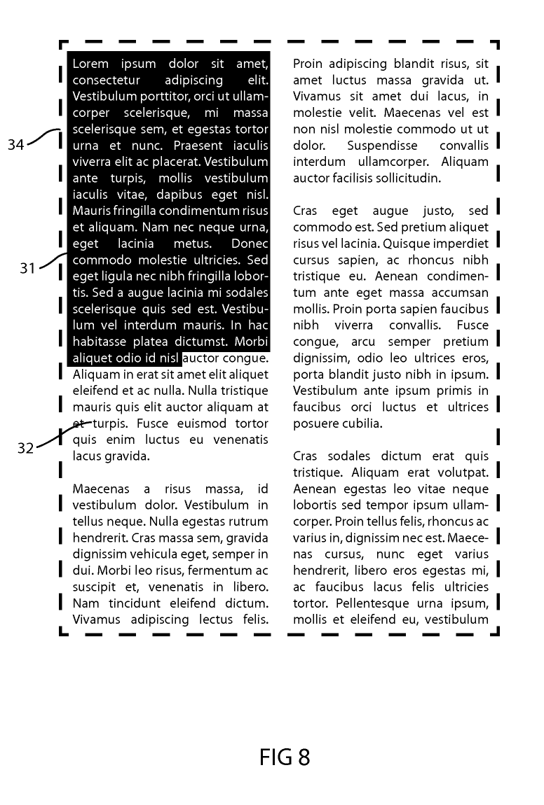

FIG. 8 illustrates the recognition phase of the invention process. The invention examines the scan or image 34 of the text page 30 containing text 32. In this embodiment, as well as identifying gaps between word blocks and lines, the system also identifies the gap between columns and thus is able to associate the word blocks into a reading order and thus select which word block images should be displayed together in order thus laying out the text blocks appropriately.

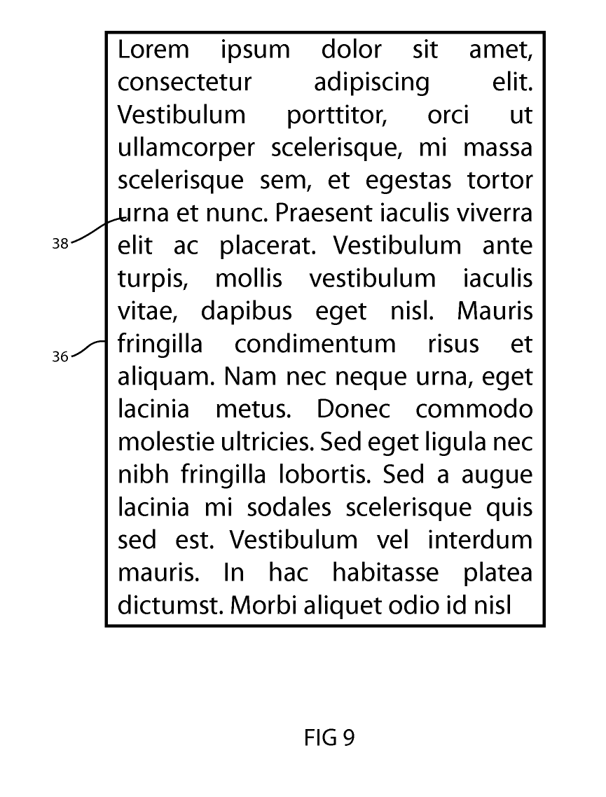

In FIG. 8 the system has identified the word blocks in area 31 (shown inverted for clarity) for display in order together. The system may then magnify, re-layout and move the identified blocks around so as to format them 38 to fit the output display 36 as shown in FIG. 9.

As previously described the invention system examines the scanned area as a bitmap image and searches for the spaces between words and the spaces between lines. These show up as contiguous areas of the background color and can be readily identified from the contrasting blocks containing text. No OCR or similar processing of the text blocks is performed; they are treated as simple images. Although two columns are illustrated here, the invention is not so limited and any number of columns may be similarly processed. As previously described in the single column embodiment, the system will correctly format the page as the user reads each screen of text and will move down one column, then switch to the second column and move down it, reformatting and displaying text blocks for the user as it does so. The end result is that the user will see all the text magnified presented to them in the correct order for reading the page, with no need for manual scanning or movement.

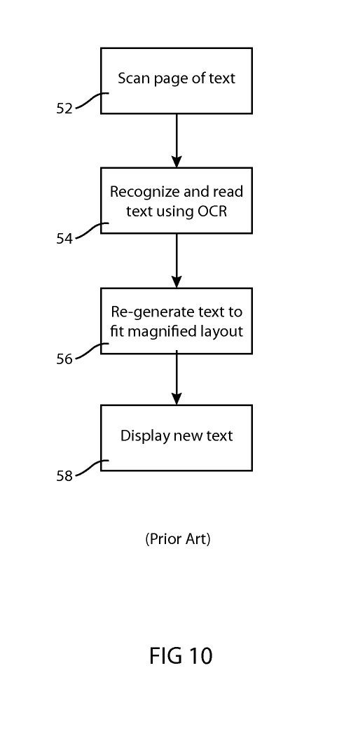

FIG. 10 illustrates the flow chart of a prior art text magnification system using OCR. This follows the following steps: 52, the page of text is scanned (the text must be well illuminated, aligned correctly, and of good contrast), at the next step 54 the image is processed to identify and extract to a text format the words using OCR. This text is then completely regenerated at step 56 to fit a new magnified layout. The final step, 58, is to display the new text. This final text has no direct relationship with the original text, it is likely that the font will have been changed and any emphasis, marks or other identification on the text will have been lost.

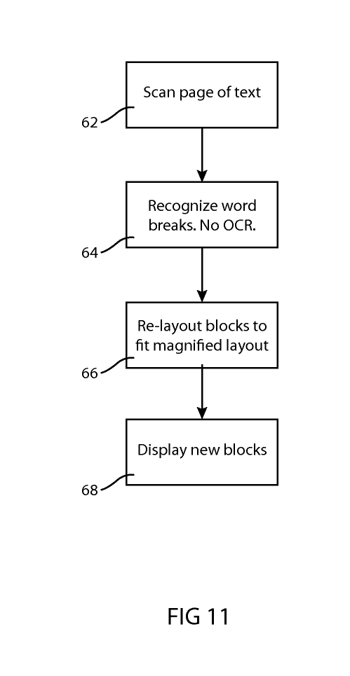

FIG. 11 illustrates the flow chart of a text magnification system of an embodiment of the invention. In step 62 the page of text is scanned (there is no requirement for good alignment and a reduced need for good contrast and illumination compared to the prior art). Step 64 is performed by a parser which parses the image into text block images. In one embodiment the text blocks are identified by looking for the contiguous areas of background. The parser also uses the contiguous back ground areas to associate the blocks with each other into a reading order. This is a very simple and computationally inexpensive process. No attempt is made to convert or identify the text itself The text blocks remain as bitmap images. Based on the determined relationship of the text blocks determined in the recognition step, the identified text blocks may then be and magnified and laid out 66 to fit the in the display 68.

Unlike the OCR solution, no text regeneration is required. The final text is an exact copy of the original text so any emphasis, marks, hand written notes or any other detail or identification on the text will be retained.

In a further embodiment of the invention the process of scanning, identifying, re-layout, and display of the magnified text may be done in real time. Unlike prior art solutions using OCR, the processing requirements are light and may be carried out rapidly by an inexpensive device such as a smartphone or tablet computer. For example, a book or magazine could be supported in a stand with a smartphone or table computer in a second stand pointing at it. Once aligned, the user can read the instantly magnified text directly on the screen of the smartphone or table and can scroll up and down on the screen of the device to read the entire page of the book or magazine. The user can then turn the page of the book or magazine, and continue to read on the smartphone or tablet. This is a simple process that can be done on the spot, with no need for pre-scanning or prior preparation of the material. The smartphone or tablet computer may be oriented in either portrait or landscape so as to suit the material being magnified.

The disclosed invention may further provide enhancement of the image to aid legibility. The image may be adjusted for visual parameters including but not limited to focus, brightness, contrast, gamma, sharpness, and color saturation. Such adjustment may be done with no need for knowledge of the textual content. As described earlier, the text blocks are treated as bitmapped images without OCR.

The invention may also magnify images or photographs on the page, either embedded within the text or within columns of text. After scanning the software may recognize an area of the page with none of the spaces or line breaks that would be seen within text. It may then classify this block as an image and magnified and displayed as a single area without re-layout. The user may scroll around these images or photographs as desired.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. A text reading aid comprising:
a parser recognizing word block in an image containing text and create word block images and associating the word blocks into a reading order;
a magnifier varying the size of the word block images; and
a formator laying out the magnifier varied word block images in accordance to said reading order.

2. The text reading aid of claim 1 further comprising:
an imager converting a text document into an electronic image file, and
a display displaying the formator layout, magnifier varied word block images.
